(19) United States
(12) Patent Application Publication
(10) Pub. No.: US 2026/0104580 A1
(43) Pub. Date: Apr. 16, 2026

(54) DIVERGENCE VARIATION COMPENSATING TELESCOPE

(71) Applicant: L3Harris Technologies, Inc., Melbourne, FL (US)

(72) Inventor: Edward MIESAK, Windermere, FL (US)

(21) Appl. No.: 18/917,358

(22) Filed: Oct. 16, 2024

(51) Int. Cl. G02B 23/06; G02B 27/64

(52) U.S. Cl. CPC G02B 23/06; G02B 27/646

(57) ABSTRACT

A telescope for an optical system includes: a first lens positioned to receive a laser beam from a laser source, the laser beam having an input beam divergence, and a second lens positioned to receive the laser beam after transmission through the first lens and to emit an output laser beam having an output beam divergence. The first and second lenses are shaped to apply an overmagnification to the laser beam, the overmagnification being greater than the magnification required to convert the input beam divergence to the output beam divergence. A distance between the first and second lenses causes the telescope to be defocused resulting in a residual divergence in the output laser beam, such that the output beam divergence is a function of the overmagnification and the residual divergence.

### TECHNICAL FIELD

The present disclosure relates to a divergence variation compensating telescope for an optical system.

### BACKGROUND

Laser systems that transmit laser signals and receive back scattered and back reflected laser signals are used in a variety of applications, such as range finding and imaging. A Laser Range Finder (LRF), for example, may be required both to transmit laser signals and to receive return laser signals that are back reflected and/or back scattered from objects in a specified field of view (FOV). The FOV is generally defined in terms of an angular extent that specifies a cone angle covered by the LRF receiver. The laser beam has its own FOV and is typically determined by the operational requirements of the overall system. Laser beams inherently diverge (expand) as they propagate from a source laser transmitter. If the laser beam divergence, which can be characterized as a cone angle, does not meet the system FOV requirements, a telescope can be used to adjust the output beam divergence. Owing to manufacturing tolerances and operating conditions such as varying temperature, laser beam divergence varies during operation and from one laser source to another. Conventional techniques for adjusting and maintaining a specific beam divergence with a telescope may not adequately address keeping variations in the system's output beam divergence within acceptance tolerances. A need remains for a technique for adjusting laser beam divergence to a desired level while also compensating for excess variation in the laser beam divergence.

### BRIEF DESCRIPTION OF THE DRAWINGS

FIG. 1 shows the beam divergence of a laser beam transmitted from a laser source, specified as a cone half angle and a cone full angle.

FIG. 2 is a diagram of an afocal telescope with input and output lenses having a positive focal length.

FIG. 3 is a diagram of an afocal telescope with an input lens having a negative focal length and an output lens having a positive focal length.

FIG. 4 is block diagram of an optical system having a laser source and a telescope to adjust the beam divergence of the laser beam transmitted by the laser source.

FIG. 5 is a diagram illustrating the principle of a defocused telescope where the telescope includes two lenses with positive focal lengths.

FIG. 6 is a diagram illustrating the principle of a defocused telescope where the telescope includes a lens with a negative focal length and a lens with a positive focal length.

FIG. 7 is a graph showing the residual divergence of a defocused telescope as a function of the displacement of the output lens relative to its afocal position.

FIG. 8 is a graph comparing the input-to-output beam divergence variation produced by an afocal telescope to the input-to-output beam divergence variation produced by a defocused telescope providing overmagnification and a residual divergence.

FIG. 9 is a diagram of a single-piece, solid-body defocused telescope that applies an overmagnification and a residual divergence to a laser beam to compensate for variation in beam divergence.

FIG. 10 is a functional flow diagram summarizing operations performed by a divergence variation compensating telescope to yield a specified average output beam divergence with a specified maximum variation.

### DESCRIPTION

### Overview

According to a disclosed embodiment, a telescope comprises: a first lens positioned to receive a laser beam from a laser source, the laser beam having an input beam divergence, and a second lens positioned to receive the laser beam after transmission through the first lens and to emit an output laser beam having a specified output beam divergence. The first and second lenses are shaped to apply an overmagnification to the laser beam, the overmagnification being greater than a magnification required to convert the input beam divergence to the specified output beam divergence. A distance between the first and second lenses causes the telescope to be defocused, resulting in a residual divergence in the output laser beam, such that the output beam divergence is a function of the overmagnification and the residual divergence. The overmagnification applied by the first and second lenses adjusts the divergence of the laser beam such that when the telescope is in focus the divergence is less than the target divergence. This overmagnification also reduces the divergence variation by the same amount as the overmagnification. The first and second lenses are positioned on an optical axis, and a distance between the first and second lenses is offset along the optical axis relative to a distance corresponding to an afocal arrangement to defocus the telescope to cause the residual divergence. The combination of the telescope's overmagnification and residual divergence enables the telescope to control not only laser beam divergence but also laser beam divergence variation.

### EXAMPLE EMBODIMENTS

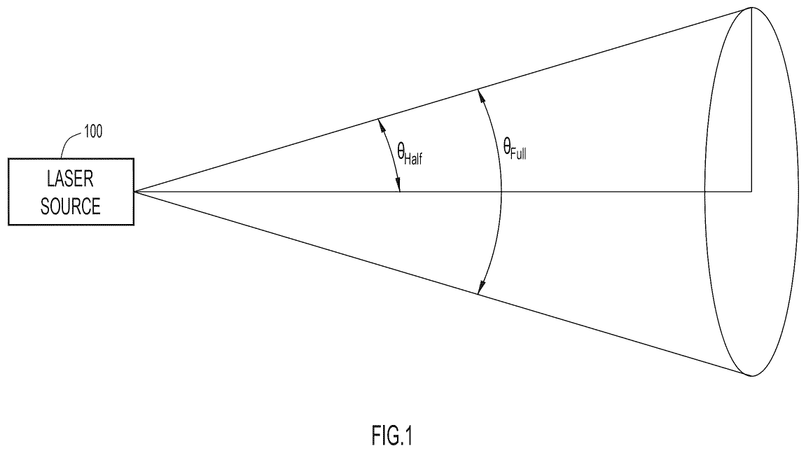

Optical systems such as Laser Range Finders (LRFs) are designed to have a specific Field Of View (FOV) for the receiver and the transmitter. The transmitter beam is typically specified in angular units that designate the cone angle of the propagating laser beam. All laser beams expand as they propagate, and this expansion is often referred to as divergence. FIG. 1 visually depicts a laser beam divergence angle of a laser beam emitted by a laser transmitter, also called a “laser source” herein. The laser beam divergence angle can be specified in terms of a cone half angle θ_{Half} or a cone full angle θ_{Full}. Unless specified otherwise, references to divergence angles described herein are cone full angles.

If the laser beam divergence (cone angle) does not meet the optical system's transmitter FOV requirement, a telescope can be used to manipulate the laser beam divergence to match the system's transmitter FOV requirement. The standard telescope used for this purpose is an afocal telescope. An afocal telescope system produces no net convergence or divergence of a collimated beam. Specifically, if a perfectly collimated laser beam enters an afocal telescope, a perfectly collimated laser beam will exit the telescope. This type of telescope can be created using two components having optical power, two lenses or two curved mirrors.

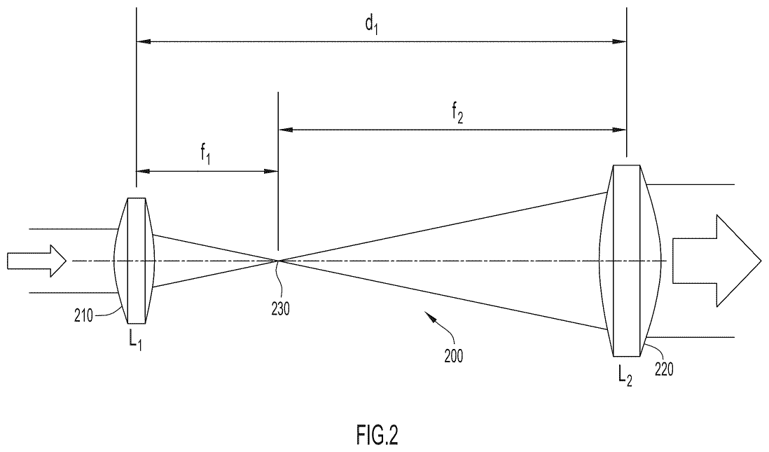

FIG. 2 illustrates a Keplerian afocal telescope 200 comprising first and second positive focal length lenses L₁ (210) and L₂ (220), each having convex input and output surfaces. Incident light from a laser source enters the telescope via first lens L₁ 210 and exits the telescope via second lens L₂ 220. First and second lenses L₁ 210 and L₂ 220 are spaced apart by a distance d₁=f₁+f₂, where f₁ is the focal length of first lens L₁ 210, and f₂ is the focal length of second lens L₂ 220. That is, the distance d₁ between the lenses is selected such that the two focal points are co-located at the same point (i.e., “overlap” at that common point). In FIG. 2, the focal points of the first and second lenses L₁ 210 and L₂ 220 overlap at the point 230, which lies in the region between the two lenses. While first and second lenses L₁ 210 and L₂ 220 respectively serve as the input and output lenses of telescope 200 for transmitted laser light, in the case of reflected laser light returning to telescope 200, second lens L₂ 220 serves as the input lens and first lens L₁ 210 serves as the output lens, which supplies the received laser signal to an optical receiver (not shown) of the optical system.

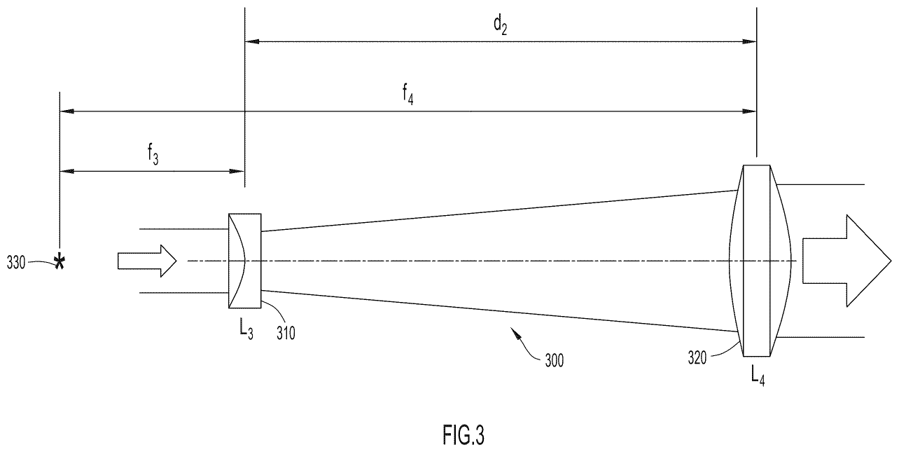

FIG. 3 illustrates a Galilean afocal telescope 300 comprising first and second lenses, L₃ 310 and L₄ 320. Here, first lens L₃ 310, which receives incident light entering the telescope from a laser source, has a concave input surface with a negative focal length f₃. Second lens L₄ 320 has a positive focal length f₄, with the focal point of second lens L₄ 320 located on the far side of first lens L₃ 310 (i.e., on the side of first lens L₃ 310 facing away from second lens L₄ 320). First and second lenses L₃ 310 and L₄ 320 are spaced apart by a distance d₂=−f₃+f₄. That is, the distance d₂ between the lenses is selected such that the two focal points are co-located at the same point (i.e., overlap) in the region on the side of the first lens L3 310 outside the region between the two lenses. The focal points of the first and second lenses L₃ 310 and L₄ 320 overlap at the point 330, which lies in the region on the outer side of first lens L₃ 310. While first and second lenses L₃ 310 and L₄ 320 respectively serve as the input and output lenses of telescope 300 for transmitted laser light, in the case of reflected laser light returning to telescope 300, second lens L₄ 320 serves as the input lens and first lens L₃ 310 serves as the output lens, which supplies the received laser signal to an optical receiver of the optical system.

While an afocal telescope does not alter the divergence of a collimated beam, it does alter the diameter of the beam according to the telescope magnification. The magnification of such a telescope is given by:

$$M = \frac{{f}_{out}}{{f}_{in}} \qquad ( 1 )$$

where fᵢₙ is the focal length of the input lens which receives incident laser light from a laser source and fₒᵤₜ is the focal length of the output lens from which the laser light exits the afocal telescope. In the case of the afocal telescope 200 shown in FIG. 2 with two positive focal length lenses, the magnification is given by M=f₂/f₁. For the afocal telescope 300 shown in FIG. 3, the magnification is given by M=f₄/f₃. Owing to their magnification of the input beam, such afocal telescopes are often referred to as beam expanders.

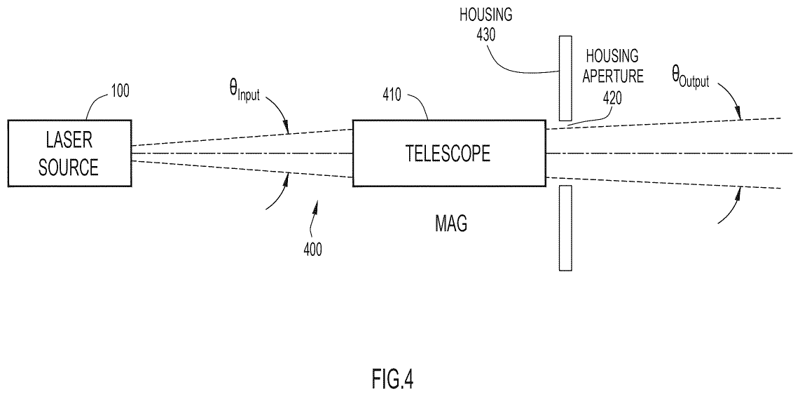

An illustration of an optical system 400 with a telescope 410 manipulating the divergence of a laser beam transmitted by a laser source 100 is shown in FIG. 4. The output divergence of the optical system's output laser beam, θ_{Output}, is generally driven by the system's operational requirements. The source laser beam divergence, θ_{Input}, is specified by the laser source's manufacturer. The source laser beam divergence θ_{Input} is typically greater than the optical system's required output beam divergence θ_{Output}. The output beam divergence θ_{Output} is reduced according to the magnification of the telescope 410, i.e., it is equal to the input beam divergence θ_{Input} divided by the telescope magnification as shown in equation (2).

$${θ}_{Output} = \frac{{θ}_{Input}}{M} \qquad ( 2 )$$

Depending on the source laser input beam divergence θ_{Input} and the required output beam divergence θ_{Output}, a significant amount of magnification from the telescope 410 may be necessary. Increasing the focal length of the output lens fₒᵤₜ of the telescope 410 to provide greater magnification according to equation (1) corresponds to an increase in the output beam diameter exiting the telescope and a decrease in the output beam divergence θ_{Output} according to equation (2). A small output beam divergence θ_{Output} exiting the telescope aperture 420 may therefore require a large beam diameter at the output of the telescope 410. The output aperture 420 of the telescope housing 430 may be limited, thereby requiring a compromise to be made between the smallest possible output beam divergence θ_{Output} and the maximum allowable size of the telescope output aperture 420.

An optical system such as an LRF may specify the required output laser beam not only in terms of an average output beam divergence θ_{Output-Avg} but also in terms of a maximum variation V_{Output} from the average output beam divergence θ_{Output-Avg} such that, in all cases, the output beam divergence θ_{Output} falls within the range of θ_{Output-Avg}+V_{Output}. Equivalently, the output beam divergence is required to be no greater than a maximum output beam divergence θ_{Output-Max}=θ_{Output-Avg}+V_{Output} and no less than a minimum output beam divergence θ_{Output-Min}=θ_{Output-Avg}−V_{Output}. Within the magnification constraints imposed by the size of the output beam diameter relative to the telescope housing's output aperture 420, it is feasible to attain a desired average output beam divergence θ_{Output-Avg} from a source laser beam having a known average source laser beam divergence θ_{Input-Avg} using an afocal telescope with a suitable magnification according to equation (2). Depending on the maximum variation of the source laser beam divergence V_{Input} from the laser source's average input beam divergence θ_{Input-Avg}, however, merely implementing an afocal telescope with the necessary magnification to achieve a desired average output beam divergence θ_{Output-Avg} from a known average source laser beam divergence θ_{Input-Avg} may not ensure that the actual output beam divergence θ_{Output} remains within the required maximum variation from the specified average output beam divergence (i.e., in the range θ_{Output-Avg}±V_{Output}) in all cases. This principle will be explained below with an example.

The actual beam divergence of a source laser beam θ_{Input} may vary from an indicated average source laser beam divergence θ_{Input-Avg} for a variety of reasons. The beam divergence of the beam transmitted by an individual laser source typically fluctuates as a function of temperature, which changes during operation, and also varies based on environmental conditions (e.g., ambient temperature). Where several optical systems are required to stay within the same maximum variation V_{Output} of the average output beam divergence θ_{Output-Avg}, the laser source beam divergence characteristics inherently vary to some degree among the overall set of laser sources owing, for example, to manufacturing tolerances. Further, if laser sources from different manufacturers are to be used within a group of optical systems required to meet the same specifications, the beam divergence characteristics will vary among the laser sources from the different manufacturers. Consequently, the source laser beam divergence θ_{Input} varies for each individual laser source during operation and varies among any set of laser sources.

As previously explained, an optical system such as an LRF may specify the required output laser beam in terms of an average output beam divergence and a maximum variation from the average output beam divergence: θ_{Output-Avg}±V_{Output}. For example, an optical system may have a required transmitter divergence of 3.5 mRad±0.35 mRad (full angle), meaning that the transmitter divergence must be greater than or equal to a minimum output beam divergence θ_{Output-Min} of 3.15 mRad and less than or equal to a maximum output beam divergence θ_{Output-Max} of 3.85 mRad over all operating temperatures across a set of optical systems.

Consider a group of laser sources that has a minimum source laser beam divergence θ_{Input-Min} of 5.89 mRad (full angle) and a maximum source laser beam divergence θ_{Input-Max} of 14.27 mRad (full angle) over a full range of operating temperatures required by the laser system specifications. In this case, the source laser's average input beam divergence θ_{Input-Avg} is 10.08 mRad, and the source laser's maximum variation from the average input beam divergence V_{Input} is 4.19 mRad.

The standard approach for a transmitter telescope design is to find the magnification that converts the average input beam divergence θ_{Input-Avg} to the optical system's required average output beam divergence θ_{Output-Avg}. According to equation (2), in this particular example, the telescope magnification would be the average source laser beam divergence θ_{Input-Avg} (10.08) divided by the required average output beam divergence θ_{Output-Avg} (3.5) or 10.08/3.5=2.88×. For this example, the exit aperture diameter in the housing is assumed to be 15 mm and the input laser beam diameter is 1 mm. Applying the 2.88× magnification to the source laser beam entering the telescope gives a beam diameter of 2.88 mm at the output of the telescope, which easily fits through the exit aperture in the housing.

This standard design procedure works if the maximum variation of the source laser beam divergence V_{Input} is relatively small. However, in this example, the maximum variation of the source laser beam divergence V_{Input} is too large to result in the output beam divergence remaining within the required range of θ_{Output-Avg}±V_{Output} in all cases. Given that the telescope magnification is set to 2.88× and that this magnification is applied to every possible divergence coming out of the source laser, Table 1 shows that the output beam divergence θ_{Output} (2.05 mRad) resulting from the source laser's minimum beam divergence θ_{Input-Min} (5.89 mRad) is less than the required minimum output beam divergence θ_{Output-Min} (3.15 mRad), and that the output beam divergence θ_{Output} (4.95 mRad) resulting from the source laser's maximum beam divergence θ_{Input-Max} (14.27 mRad) is greater than the required maximum output beam divergence θ_{Output-Max} (3.85 mRad).

TABLE 1
(Afocal telescope - Mag. 2.88x, average output beam divergence meets
specification, divergence variation not within specification)

| | Source Laser | Output Beam | Laser System | Output Beam |
|---|---|---|---|---|
| | Beam Divergence | Divergence | Specification | Divergence Meets |
| | (mRad) | (mRad) | (mRad) | Specification? |
| Minimum | 5.89 | 2.05 | 3.15 | No - under minimum |
| Average | 10.08 | 3.5 | 3.5 | Yes |
| Maximum | 14.27 | 4.95 | 3.85 | No - over maximum |

As will be appreciated from the example summarized in Table 1, the telescope magnification M that would adjust the source laser's input beam divergence θ_{Input-Avg} to the optical system's required output beam divergence θ_{Output-Avg} (in this example, M=2.88×) may be insufficient to reduce the maximum variation of the source laser's input beam divergence V_{Input} to be within the maximum variation of the output beam divergence V_{Output}. In this case, to ensure that the maximum variation of the output beam divergence V_{Output} requirement is met, the telescope magnification can be increased to yield the maximum variation of the output beam divergence V_{Output} to the required level according to equation (3). Specifically, the magnification corresponds to a ratio of the maximum variation of the input beam divergence to the maximum variation of the output beam divergence.

$${V}_{Output} = \frac{{V}_{Input}}{M} \qquad ( 3 )$$

However, increasing the telescope magnification to reduce the maximum variation in the output beam divergence V_{Output} to an acceptable level will also reduce the nominal or average output beam divergence θ_{Output-Avg} so that some or all the output beam divergences will be too small, i.e., less than the required minimum output beam divergence θ_{Output-Min}, and the average output beam divergence requirement θ_{Output-Avg} will not be met. Taking the example above, if the telescope magnification M were to be increased to 12×, the maximum variation requirement of the output beam divergence (±0.35 mRad) is now met. Specifically, applying the telescope magnification of 12×, the output beam divergence θ_{Output} resulting from the source laser's minimum input beam divergence θ_{Input-Min} (5.89 mRad) is 0.49 mRad (5.89/12), the output beam divergence θ_{Output} resulting from the source laser's maximum input beam divergence θ_{Input-Max} (14.27 mRad) is 1.19 (14.27/12), and the average output beam divergence θ_{Output-Avg} resulting from the source laser's average input beam divergence θ_{Input-Avg} is 0.84 mRad (10.08/12). Thus, the maximum variation in the output beam divergence V_{Output} is within the ±0.35 mRad specification (1.19−0.84=0.35 mRad, and 0.49−0.84=−0.35 mRad). However, the entire range of output beam divergences (0.49 mRad to 1.19 mRad) now falls outside (below) the specified output divergence range of 3.15 to 3.85 mRad. That is, the output beam divergence θ_{Output} would be too small over all operating conditions, as summarized in Table 2, below.

TABLE 2
(Afocal telescope - Mag. 12x, beam divergence variation within
specification, beam divergence does not meet specification)

| | Source Laser | Output Beam | Laser System | Output Beam |
|---|---|---|---|---|
| | Beam Divergence | Divergence | Specification | Divergence Meets |
| | (mRad) | (mRad) | (mRad) | Specification? |
| Minimum | 5.89 | 0.49 | 3.15 | No - under minimum |
| Average | 10.08 | 0.84 | 3.5 | No - under minimum |
| Maximum | 14.27 | 1.19 | 3.85 | No - under minimum |

The disclosed divergence variation compensating telescope enables a given laser source to meet both the average output beam divergence θ_{Output-Avg} and the maximum variation in the output beam divergence V_{Output} specified for an optical system by applying the combination of overmagnification and a “residual” divergence to the input laser beam. As used herein, the terms “overmagnification,” “overmagnify,” “overmagnifying,” etc. refer to a telescope in which the first and second lenses are shaped to apply a magnification to the input laser beam that is greater than the magnification required to produce a specified average output beam divergence θ_{Output-Avg} from an average input laser beam divergence θ_{Input-Avg}. As shown in the example summarized in Table 2, a higher magnification level can be selected to scale the input source laser beam maximum variation divergence V_{Input} down to the optical system's required maximum variation V_{Output} from the average output beam divergence θ_{Output-Avg} according to equation (3). Thus, the overmagnification applied by the relative focal lengths of first and second lenses of the telescope adjusts the divergence of the laser beam such that a specified maximum variation of the output beam divergence can be met by a manufacturer's indicated maximum variation of the input beam divergence.

Having set the magnification to a level that keeps the maximum variation of the output beam divergence V_{Output} within the system's acceptable tolerance, the telescope is also designed to apply a “residual” divergence to shift the resulting average output beam divergence to match the system's required average output beam divergence θ_{Output-Avg}. While the telescope's residual divergence shifts the output beam divergence to the target level, this residual divergence does not greatly impact the maximum variation of the output beam divergence V_{Output} achieved with overmagnification. That is, the residual divergence essentially adds a constant to the divergence resulting from the overmagnification but does not appreciably change the “spread” of the divergence, i.e., divergence variation, that may occur, thereby preserving the maximum variation range set by the overmagnification level. In effect, once a magnification level of the telescope has been selected to scale the input beam divergence range down to the required output beam divergence range, the residual divergence can be independently selected to shift the divergence variation range to be centered about the required average output beam divergence θ_{Output-Avg}.

A residual divergence can be obtained from a “defocused” telescope having a misalignment between the lenses of the telescope. The afocal telescope shown in FIG. 2 is fully aligned, because the focal points of the first and second lenses L₁ 210 and L₂ 220 overlap at the common point 230. Likewise, the afocal telescope shown in FIG. 3 is fully aligned, because the focal points of the first and second lenses L₃ 310 and L₄ 320 overlap at the common point 330. This overlap at a common point is achieved by properly setting the distance between the lenses according to the focal distances of the lenses. In FIG. 2, the first and second lenses L₁ 210 and L₂ 220 are spaced apart by a distance d₁=f₁+f₂, i.e., the sum of the focal length of the lenses, and in FIG. 3, the first and second lenses L₃ 310 and L₄ 320 are space apart by a distance d₂=−f₃+f₄. The distance d₁ between the lenses in the afocal telescope shown in FIG. 2 and the distance d₂ between the lenses in the afocal telescopes shown in FIG. 3 can be considered an “afocal distance” between the lenses, indicating that these distances produce an afocal arrangement based on the focal lengths of the lenses. If the actual distance between the lenses is less than the afocal distance d₁ or d₂, then the telescope will have a residual divergence that is positive. A telescope that has a positive divergence means the output laser beam expands as it propagates (e.g., a collimated input beam with no divergence will have a positive, expanding divergence at the telescope output). If the actual distance between the lenses is greater than the focal distance d₁ or d₂, the residual divergence will be negative. A negative divergence means the output laser beam gets smaller as it propagates. A telescope that has a net positive or negative divergence is referred to as “out of focus” or “defocused,” in comparison to an afocal telescope, which is “focused.”

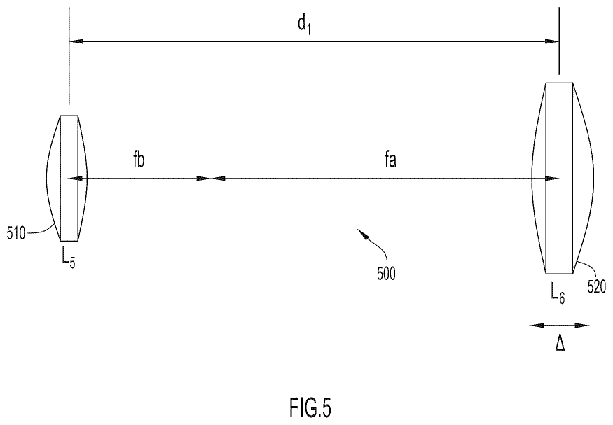

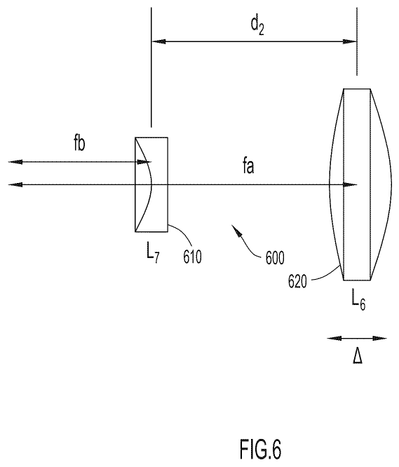

The concept of a defocused telescope is illustrated in FIGS. 5 and 6. In FIG. 5, an afocal telescope 500 comprising first and second positive lenses L₅ and L₆ is shown. In FIG. 6, an afocal telescope 600 comprising a first, negative lens L₇ and a second, positive lens L₆ (i.e., both telescopes 500 and 600 have the same output lens L₆). In each case, the first lens positioned on an optical axis to receive a laser beam from a laser source, where the laser beam has an input beam divergence. The second lens L₆ is positioned on the optical axis at a distance from the first lens to receive the laser beam after transmission through the first lens, and the second lens emits an output laser beam having an output beam divergence. Like the afocal telescopes in FIGS. 2 and 3, each telescope 500, 600 is an afocal telescope when the distance between its lenses is equal to the sum of the focal lengths of its lenses. For telescope 500, the distance d₁ between lenses L₅ and L₆ is given by d₁=f_{b}+fₐ, where f_{b} is the focal length of lens L₅ and f_{b} is the focal length of lens L₆. For telescope 600, the distance de between lenses L₇ and L₆ is given by d₂=−f_{b}+fₐ, where f_{b} is the focal length of lens L₇. Telescope 600 is shorter than telescope 500 by 2 f_{b} because lens L₇ has a negative focal length. The magnification of both telescopes is equal because the focal length of lens L₇ is equal to the focal length of L₅ (both are |f_{b}|).

If lens L₆ in telescope 500 or 600 is moved some amount Δ on the optical axis relative to the afocal position, then telescopes 500, 600 are no longer afocal. In this condition, the telescopes contain a residual divergence or convergence, and the telescopes 500, 600 can be referred to as being “out of focus” or “defocused.” The amount of residual divergence/convergence can be simulated by equation 4 below.

$$ResDiv = \frac{175 Δ}{{f}_{ι}} \qquad ( 4 )$$

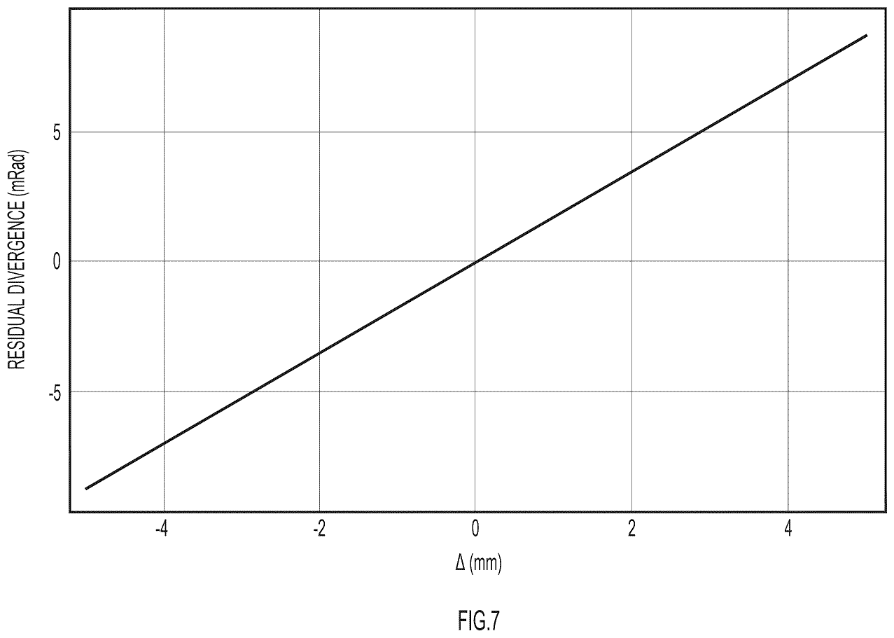

The variable f₁ is the focal length of lens L₆. The variable Δ is the amount that lens L₆ is moved from its afocal position (i.e., an offset from the “afocal distance” between the first and second lenses along the optical axis). FIG. 7 is a graph showing the residual divergence of a defocused telescope as a function of the displacement Δ (in mm) of the output lens L₆ relative to its afocal position assuming lens L₆ has a focal length of 100 mm. Moving the lenses closer together, corresponding to a positive displacement (“offset” or “shift”) Δ, generates a positive residual divergence, i.e., the output laser beam expands more as it propagates than it would from the same telescope with the lenses arranged at the afocal distance. Moving the lenses farther apart, corresponding to a negative displacement (offset or shift) −Δ, generates a negative residual divergence, i.e., the beam expands less than it would from the same telescope with the lenses arranged at the afocal distance.

In the case of an input source laser beam having a divergence θ_{Input} and telescope having overmagnification to adjust the maximum variation of the input source laser beam divergence V_{Input} to the required maximum variation of the output beam divergence V_{Output}, the resulting output beam divergence will be less than the required average output beam divergence θ_{Output-Avg}, and a positive residual divergence can be used to adjust the output beam divergence to meet the required average output beam divergence θ_{Output-Avg}. The residual divergence caused by the misalignment of the defocused telescope is added to the beam divergence resulting from the magnification applied by the telescope to the input beam divergence according to equation (5) below.

$${θ}_{Output} = \frac{{θ}_{Input}}{M} + ResDiv \qquad ( 5 )$$

Thus, if a telescope is defocused by shifting the spacing between the lenses relative to the afocal arrangement, the resulting residual divergence is uniformly added all the divergences exiting the telescope. If a perfectly collimated laser beam, i.e., a laser with a full angle beam divergence of 0 mRad, were to pass through a telescope with 2.66 mRad of residual divergence, the output divergence would be 2.66 mRad. Returning to the example summarized in Table 2, in which an overmagnification is used to achieved the desired maximum variation of the output beam divergence V_{Output} but causes the output beam divergences θ_{Output} to be too small, a residual divergence of 2.66 mRad built into the telescope uniformly increases all the output divergences by 2.66 mRad, which brings all possible output laser beam divergences θ_{Output} within the requirement, as shown in Table 3. Specifically, the 12× overmagnification has the effect of converting the average input (source laser) beam divergence θ_{Input}-Avg of 10.08 mRad to 0.84 mRad (10.08/12=0.84, see Table 2), but by adding a residual divergence of 2.66 mRad to this value, the resulting average output beam divergence θ_{Output}-Avg is 3.5 mRad (0.84+2.66=3.5). Likewise, the 12× overmagnification converts the minimum input beam divergence θ_{Input-Min} of 5.89 mRad to 0.49 mRad (5.89/12=0.49), but by adding the residual divergence of 2.66 mRad to this value, the resulting minimum output beam divergence θ_{Output-Min} is 3.15 mRad (0.49+2.66=3.15). The 12× overmagnification converts the maximum input beam divergence θ_{Input-Max} of 14.27 mRad to 1.19 mRad (14.27/12=1.19), but by adding the residual divergence of 2.66 mRad to this value, the resulting maximum output beam divergence θ_{Output-Max} is 3.85 mRad (1.19+2.66=3.85). Thus, the telescope is designed such that its overmagnification M converts the variation range of the source laser's input beam divergence ±V_{Input} to a desired variation range of the output beam divergence ±V_{Output}. The distance between the first and second lenses, which is offset from the afocal distance, causes the telescope to be defocused, resulting in a residual divergence in the output laser beam. Telescope's residual divergence ResDiv shifts the variation range of the output beam divergence ±V_{Output} to be centered at the desired average output beam divergence θ_{Output-Avg}, such that the output beam divergence is a function of the overmagnification and the residual divergence. If the laser beam diameter entering the telescope is assumed to be 1 mm, the magnification of 12× makes the output laser beam 12 mm in diameter. This output beam fits through the system exit aperture of 15 mm in this example.

TABLE 3
(Defocused telescope - Mag. 12x, 2.66 mRad residual divergence, beam
divergence and divergence variation meet/within specifications)

| | Source Laser | Output Beam | Laser System | Output Beam |
|---|---|---|---|---|
| | Beam Divergence | Divergence | Specification | Divergence Meets |
| | (mRad) | (mRad) | (mRad) | Specification? |
| Minimum | 5.89 | 3.15 | 3.15 | Yes |
| Average | 10.08 | 3.5 | 3.5 | Yes |
| Maximum | 14.27 | 3.85 | 3.85 | Yes |

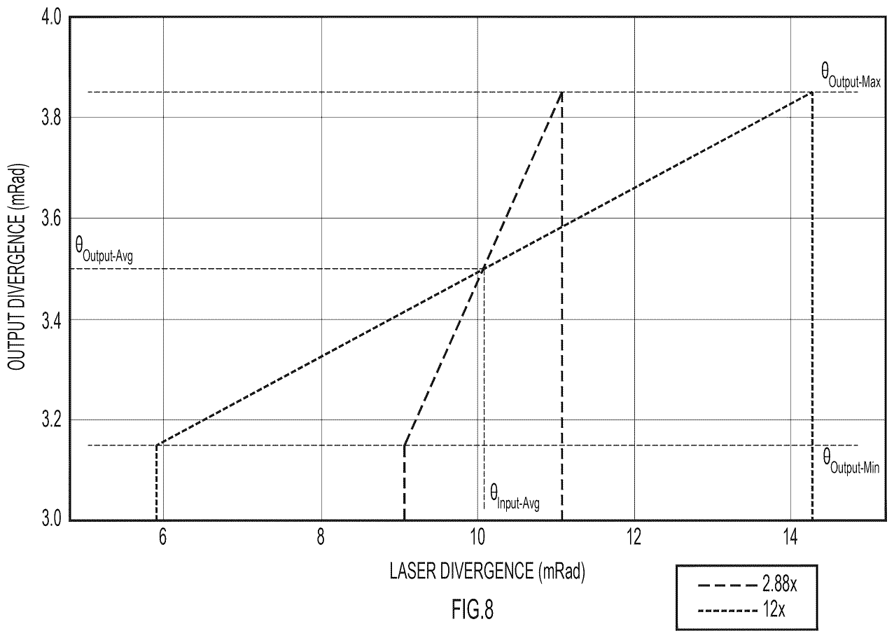

The graph in FIG. 8 illustrates the advantage of using a telescope having overmagnification and a residual divergence compared to a standard afocal telescope when adjusting an input source laser beam divergence θ_{Input} to an optical system's output beam divergence θ_{Output}. Staying with the example of a source laser having an average beam divergence θ_{Input-Avg} of 10.08 mRad and a required average output beam divergence θ_{Output-Avg} of 3.5 mRad, if an afocal telescope with a magnification 2.88× is used to convert this average input beam divergence θ_{Input-Avg} to this required output beam divergence θ_{Output-Avg} (the scenario summarized in Table 1), only a source laser with a relatively small maximum variation of beam divergence V_{Input} will meet the required maximum variation of the output beam divergence. Specifically, the maximum variation of the input beam divergence V_{Input} can be no greater than ±1.00800 mRad relative to the average input beam divergence θ_{Input-Avg} (10.08 mRad) to meet the required maximum variation of the output beam divergence V_{Output} of ±0.35 mRad (i.e., the input beam divergence must remain in the divergence range of 9.072 mRad to 11.088 mRad across all operating conditions and devices (see the thick, coarsely dashed line profile). In comparison, a telescope having a 12× magnification and a residual divergence of 2.66 mRad enables a source laser having a much greater maximum variation of the input beam divergence V_{Input} of ±4.19 mRad to meet this same maximum variation of the output beam divergence requirement V_{Output} (see the thick, finely dashed line profile), i.e., the scenario summarized in Table 3). In practical terms, the defocused telescope with overmagnification greatly relaxes the divergence specifications required for the source laser, which may reduce the cost of the optical system significantly.

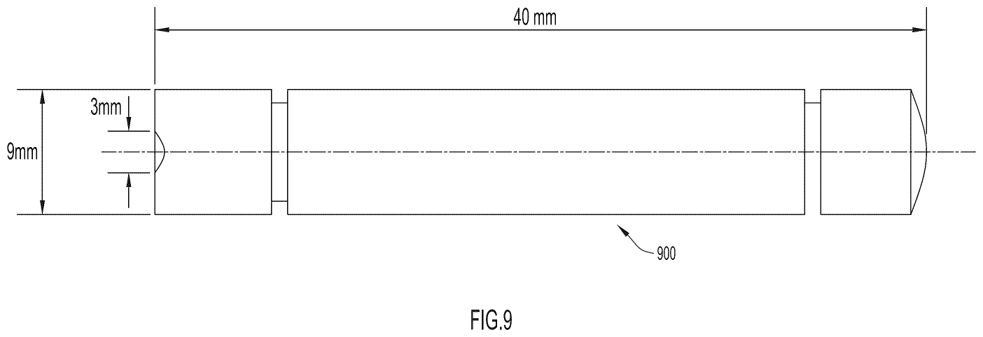

FIG. 9 is a diagram illustrating a divergence variation compensating telescope 900 comprising an optical element constructed from a single, solid piece of glass or other material transmissive to the laser's wavelength (e.g., silicon) to minimize misalignment and defocus issues during operating conditions such as shock, vibration, and temperature excursions. The body of the optical element is substantially cylindrical with the first lens of the telescope located on one end surface of the cylindrical body and centered about an optical axis extending through the center line of the cylindrical body. The second lens of the telescope is located on the other end surface of the cylindrical body and also centered on the optical axis. That is, both ends of the solid, cylindrical body have curved surfaces that function as the telescope's lenses. Because the size of the output lens impacts the magnification achievable with the telescope, the diameter of the cylindrical body of the optical element is made as large as necessary to accommodate the telescope magnification required by the optical system, within the constraint of the size of the aperture in the optical system's housing. In general, the larger the cylindrical diameter, the higher the optical magnification possible. In the non-limiting example shown in FIG. 9, the solid-piece optical element has an overall diameter of 9 mm and a length of 40 mm. Two O-ring grooves are positioned along the length of the optical element for mechanical mounting.

According to a non-limiting example, the optical element can be made of S-NPH2 glass manufactured by Ohara, which has a high index of refraction. While the solid-piece optical element does not need to be high-index, a high-index material enables the telescope to be shorter in length along the optical axis for a given magnification, and allows the size of the input surface curvature forming the input lens to be larger for a given magnification, which simplifies machining of the input surface to form the input lens during manufacture.

To reduce its length, the single-piece, solid-body telescope 900 is a Galilean telescope (i.e., the design shown in FIG. 3), with a concave entry surface having a 3 mm diameter that forms the input lens having a negative focal length. It will be appreciated that the first surface could also be convex, resulting in an input lens with a positive focal length (i.e., like the arrangement shown in FIG. 2), but this design would result in a longer structure. The curvature of the input surface, which defines the input lens' focal length, is selected to produce a beam that fits through the telescope output aperture without significant diffraction, i.e., in the far-field profile of the beam, ≥90% of the total energy is contained within the central lobe. The curvature of the output surface, which defines the output lens' focal length, is selected to ensure the nominal far-field divergence specification of the output laser beam is met using the nominal (average) input laser beam divergence. The telescope magnification is determined by the beam diameter at the telescope input surface and the beam diameter at the telescope output surface (i.e., the ratio of the output beam diameter to the input beam diameter). In this non-limiting example, the nominal value for the magnification is about 12×.

According to one example, the curvatures of the input surface serving as the input lens and the output surface serving as the output lens can be machined according to the paraboloid shape given by equation (6).

$$Z = \frac{{Y}^{2}}{R ( 1 + \sqrt{1 - ( 1 + k ) \frac{{Y}^{2}}{{R}^{2}}} )} + {A}_{2} {Y}^{2} + {A}_{3} {Y}^{3} + {A}_{4} {Y}^{4} + {A}_{5} {Y}^{5} + {A}_{6} {Y}^{6} + ⋯ \qquad ( 6 )$$

Equation (6) is based on starting with a spherical radius, R, and then deviating from the sphere into a paraboloid based on variables k and A. The value Y is the deviation off the optical axis (vertical direction in FIG. 9), and the value Z is the deviation along the optical axis (horizontal centerline in FIG. 9). The input curvature operating as the input lens can be formed using the following values, for example: R=−2 mm; k=−0.5; A₂=3×10⁻⁵. The higher order terms are omitted in this example. The output surface operating as the output lens can be formed using the following values, for example: R=−20 mm; k=−0.3; A₂=−5×10⁻⁷. The higher order terms are omitted in this example. To reduce optical distortion in the output beam, the surface curvatures can be formed with more complex shapes using higher order variables A₃, A₄, etc. represented in equation (6).

While the example shown in FIG. 9 employs a solid-body, single-piece optical element to implement the telescope, it will be appreciated that the telescope can be implemented with two separate lenses spaced at a distance from each other in a gaseous environment or in a vacuum, such as the arrangements shown in FIGS. 5 and 6.

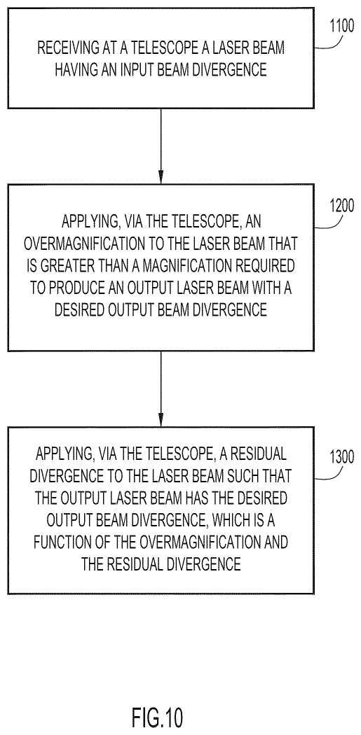

A method of compensating for the divergence variation of a laser beam is summarized in the flow diagram of FIG. 10. In operation 1100, a laser beam from a laser source is received at a telescope, where the laser beam has an input beam divergence. In operation 1200, an overmagnification is applied to the laser beam by the telescope, where the overmagnification is greater than a magnification required to produce an output laser beam with a desired output beam divergence. In operation 1300, a residual divergence is applied to the laser beam by the telescope such that the output laser beam has the desired output beam divergence, which is a function of the overmagnification and the residual divergence.

The operation of receiving the laser beam may include receiving the laser beam at a first lens of the telescope, and a second lens of the telescope receiving the laser beam after transmission through the first lens and emitting the output laser beam, wherein the first and second lenses are shaped to apply the overmagnification to the laser beam. The operation of applying the overmagnification may include adjusting the divergence of the laser beam such that a specified maximum variation of the output beam divergence is met by a specified maximum variation of the input beam divergence. The operation of applying the residual divergence may result from a distance between the first and second lenses being shifted along an optical axis of the telescope relative to an afocal distance between the first and second lenses to defocus the telescope, such that the residual divergence shifts an average output beam divergence resulting from the overmagnification to meet the desired output beam divergence.

Advantageously, the described defocused telescope requires no adjustments during operation and controls laser beam divergence variation passively using overmagnification and residual divergence. The described the defocused telescope can be used to control laser beam divergence variation in a wide range of optical systems including Laser Range Finders (LRF), and imaging systems, including medical imaging systems.

In some aspects, the techniques described herein relate to a telescope comprising: a first lens positioned to receive a laser beam from a laser source, the laser beam having an input beam divergence; and a second lens positioned to receive the laser beam after transmission through the first lens and to emit an output laser beam having an output beam divergence, wherein: the first and second lenses are shaped to apply an overmagnification to the laser beam, the overmagnification being greater than a magnification required to convert the input beam divergence to the output beam divergence, and wherein a distance between the first and second lenses causes the telescope to be defocused resulting in a residual divergence in the output laser beam, such that the output beam divergence is a function of the overmagnification and the residual divergence.

In some aspects, the techniques described herein relate to a telescope, wherein the overmagnification applied by the first and second lenses adjusts the input beam divergence of the laser beam such that a specified maximum variation of the output beam divergence is met by a specified maximum variation of the input beam divergence.

In some aspects, the techniques described herein relate to a telescope, wherein the overmagnification corresponds to a ratio of the specified maximum variation of the input beam divergence to the specified maximum variation of the output beam divergence.

In some aspects, the techniques described herein relate to a telescope, wherein the first and second lenses are positioned on an optical axis, and a distance between the first and second lenses is shifted along the optical axis relative to an afocal distance between the first and second lenses to defocus the telescope to cause the residual divergence.

In some aspects, the techniques described herein relate to a telescope, wherein the distance between the first and second lenses is less than the afocal distance, resulting in a positive residual divergence that increases the output beam divergence.

In some aspects, the techniques described herein relate to a telescope, wherein the first and second lenses have positive focal lengths.

In some aspects, the techniques described herein relate to a telescope, wherein the first lens has a negative focal length and the second lens has a positive focal length.

In some aspects, the techniques described herein relate to a telescope, comprising an optical element having an input surface and an output surface, wherein the first lens is located on input surface and the second lens is located on the output surface.

In some aspects, the techniques described herein relate to a telescope, wherein the optical element is a single-piece, solid-body optical element.

In some aspects, the techniques described herein relate to a telescope, wherein the optical element has a substantially cylindrical body.

In some aspects, the techniques described herein relate to an optical system, comprising: a laser source to transmit a laser beam having an input beam divergence; and a defocused telescope comprising: a first lens positioned to receive the laser beam from the laser source; and a second lens positioned to receive the laser beam after transmission through the first lens and to emit an output laser beam having an output beam divergence that is a function of an overmagnification and a residual divergence applied to the laser beam by the first and second lenses, the overmagnification being greater than a magnification required to convert the input beam divergence to the output beam divergence, and the residual divergence resulting from the defocused telescope being out of focus.

In some aspects, the techniques described herein relate to an optical system, wherein the overmagnification applied by the first and second lenses adjusts the input beam divergence of the laser beam such that a specified maximum variation of the output beam divergence is met by a specified maximum variation of the input beam divergence.

In some aspects, the techniques described herein relate to an optical system, wherein the first and second lenses are positioned on an optical axis, and a distance between the first and second lenses is shifted along the optical axis relative to an afocal distance between the first and second lenses to defocus the telescope to cause the residual divergence.

In some aspects, the techniques described herein relate to an optical system, wherein the optical system is a laser range finder (LRF).

In some aspects, the techniques described herein relate to an optical system, wherein the optical system is an imaging system.

In some aspects, the techniques described herein relate to a method of compensating divergence variation in a laser beam, comprising: receiving, at a telescope, a laser beam from a laser source, the laser beam having an input beam divergence; applying, via the telescope, an overmagnification to the laser beam that is greater than a magnification required to produce an output laser beam with a desired output beam divergence; and applying, via the telescope, a residual divergence to the laser beam such that the output laser beam has the desired output beam divergence, which is a function of the overmagnification and the residual divergence.

In some aspects, the techniques described herein relate to a method of compensating divergence variation in a laser beam, wherein receiving the laser beam comprises receiving the laser beam at a first lens of the telescope, wherein a second lens of the telescope receives the laser beam after transmission through the first lens, the second lens emitting the output laser beam, the first and second lenses being shaped to apply the overmagnification to the laser beam.

In some aspects, the techniques described herein relate to a method of compensating divergence variation in a laser beam, wherein applying the overmagnification adjusts the input beam divergence of the laser beam such that a specified maximum variation of the output beam divergence is met by a specified maximum variation of the input beam divergence.

In some aspects, the techniques described herein relate to a method of compensating divergence variation in a laser beam, wherein applying the residual divergence results from a distance between the first and second lenses being shifted along an optical axis of the telescope relative to an afocal distance between the first and second lenses to defocus the telescope.

In some aspects, the techniques described herein relate to a method of compensating divergence variation in a laser beam, wherein the residual divergence shifts an average output beam divergence resulting from the overmagnification to meet the desired output beam divergence.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A telescope, comprising:
a first lens positioned to receive a laser beam from a laser source, the laser beam having an input beam divergence; and
a second lens positioned to receive the laser beam after transmission through the first lens and to emit an output laser beam having an output beam divergence, wherein:
the first and second lenses are shaped to apply an overmagnification to the laser beam, the overmagnification being greater than a magnification required to convert the input beam divergence to the output beam divergence; and
a distance between the first and second lenses causes the telescope to be defocused resulting in a residual divergence in the output laser beam, such that the output beam divergence is a function of the overmagnification and the residual divergence.

2. The telescope of claim 1, wherein the overmagnification applied by the first and second lenses adjusts the input beam divergence of the laser beam such that a specified maximum variation of the output beam divergence is met by a specified maximum variation of the input beam divergence.

3. The telescope of claim 2, wherein the overmagnification corresponds to a ratio of the specified maximum variation of the input beam divergence to the specified maximum variation of the output beam divergence.

4. The telescope of claim 1, wherein the first and second lenses are positioned on an optical axis, and a distance between the first and second lenses is shifted along the optical axis relative to an afocal distance between the first and second lenses to defocus the telescope to cause the residual divergence.

5. The telescope of claim 4, wherein the distance between the first and second lenses is less than the afocal distance, resulting in a positive residual divergence that increases the output beam divergence.

6. The telescope of claim 1, wherein the first and second lenses have positive focal lengths.

7. The telescope of claim 1, wherein the first lens has a negative focal length and the second lens has a positive focal length.

8. The telescope of claim 1, further comprising an optical element having an input surface and an output surface, wherein the first lens is located on input surface and the second lens is located on the output surface.

9. The telescope of claim 8, wherein the optical element is a single-piece, solid-body optical element.

10. The telescope of claim 8, wherein the optical element has a substantially cylindrical body.

11. An optical system, comprising:
a laser source to transmit a laser beam having an input beam divergence; and
a defocused telescope comprising:
a first lens positioned to receive the laser beam from the laser source; and
a second lens positioned to receive the laser beam after transmission through the first lens and to emit an output laser beam having an output beam divergence that is a function of an overmagnification and a residual divergence applied to the laser beam by the first and second lenses, the overmagnification being greater than a magnification required to convert the input beam divergence to the output beam divergence, and the residual divergence resulting from the defocused telescope being out of focus.

12. The optical system of claim 11, wherein the overmagnification applied by the first and second lenses adjusts the input beam divergence of the laser beam such that a specified maximum variation of the output beam divergence is met by a specified maximum variation of the input beam divergence.

13. The optical system of claim 11, wherein the first and second lenses are positioned on an optical axis, and a distance between the first and second lenses is shifted along the optical axis relative to an afocal distance between the first and second lenses to defocus the telescope to cause the residual divergence.

14. The optical system, of claim 11, wherein the optical system is a laser range finder (LRF).

15. The optical system, of claim 11, wherein the optical system is an imaging system.

16. A method of compensating divergence variation in a laser beam, comprising:
receiving, at a telescope, a laser beam from a laser source, the laser beam having an input beam divergence;
applying, via the telescope, an overmagnification to the laser beam that is greater than a magnification required to produce an output laser beam with a desired output beam divergence; and
applying, via the telescope, a residual divergence to the laser beam such that the output laser beam has the desired output beam divergence, which is a function of the overmagnification and the residual divergence.

17. The method of claim 16, wherein:
receiving the laser beam comprises receiving the laser beam at a first lens of the telescope, wherein a second lens of the telescope receives the laser beam after transmission through the first lens, the second lens emitting the output laser beam, the first and second lenses being shaped to apply the overmagnification to the laser beam.

18. The method of claim 17, wherein:
applying the residual divergence results from a distance between the first and second lenses being shifted along an optical axis of the telescope relative to an afocal distance between the first and second lenses to defocus the telescope.

19. The method of claim 16, wherein:
applying the overmagnification adjusts the input beam divergence of the laser beam such that a specified maximum variation of the output beam divergence is met by a specified maximum variation of the input beam divergence.

20. The method of claim 16, wherein:
the residual divergence shifts an average output beam divergence resulting from the overmagnification to meet the desired output beam divergence.
